(19) United States
(12) Patent Application Publication
(10) Pub. No.: US 2017/0331305 A1
(43) Pub. Date: Nov. 16, 2017

(54) ADAPTER, POWER SUPPLY DEVICE, AND OVER-DISCHARGE PROTECTION METHOD

(71) Applicant: CHERVON (HK) LIMITED, Wanchai (HK)

(72) Inventors: Yingdian Xiang, Nanjing (CN); Zheng Geng, Nanjing (CN); Zhongchao Hu, Nanjing (CN); Hong Zhu, Nanjing (CN)

(21) Appl. No.: 15/585,393

(22) Filed: May 3, 2017

(30) Foreign Application Priority Data
May 16, 2016 (CN) 201610324418.7

(51) Int. Cl. H02J 7/00

(52) U.S. Cl. CPC H02J 7/0029; H02J 7/007; H02J 7/0045; H02J 7/0063; H02J 2007/004

(57) ABSTRACT

A power supply device includes a battery pack for storing electric energy and an adapter for outputting the electric energy stored in the battery pack. The battery pack includes a battery controller for detecting the voltage of the battery pack. The adapter includes an adapter controller for receiving a signal sent by the battery controller and stopping the adapter outputting the electric energy when a length of time that the battery pack has the voltage less than a predetermined voltage threshold reaches a predetermined length of time.

### RELATED APPLICATION INFORMATION

This application claims the benefit under 35 U.S.C. §119(a) of Chinese Patent Application No. CN 2016103244187, filed on May 16, 2016, the disclosure of which is incorporated herein by reference in its entirety.

### FIELD OF THE DISCLOSURE

The present invention relates to an adapter, a power pack which outputs electric energy through the adapter, and an over-discharge protection method of the battery pack.

### BACKGROUND OF THE DISCLOSURE

Battery packs working as a power source of a power tool generally have large battery capacity. During charging and discharging processes, the battery pack has large current and voltage output. In the absence of other power sources, in order to satisfy the user's need that is being able to use the battery pack of the power tool to supply power to other electrical appliances, such as cellphones, it is needed to design an adapter to adapt the battery pack. Thus, the battery pack of the power tool can supply power to cellphones, flat computers, etc., through the adapter.

During the process that the battery pack consumes its electric energy to charge the electrical appliance such as the cellphone, the voltage of the battery pack drops constantly due to the consumption of the electric energy. Meanwhile, an over-discharge problem is possible to occur. However, the over-discharge may result in damage of the battery pack, which may affect the service time of the battery pack.

The statements in this section merely provide background information related to the present disclosure and may not constitute prior art.

### SUMMARY

In one aspect of the disclosure, a power supply device is provided. The power supply device includes a battery pack for supplying electric energy to at least a power tool and an adapter for outputting the electric energy stored in the battery pack. The battery pack includes cells for storing the electric energy, a battery pack positive terminal connected with a positive electrode of the cells, a battery pack negative terminal connected with a negative electrode of the cells, a battery controller for detecting voltage of the battery pack, and a first communication terminal electrically connected with the battery controller. The adapter includes an input positive terminal for connecting with the battery pack positive terminal, an input negative terminal for connecting with the battery pack negative terminal, a second communication terminal for electrically connecting with the first communication terminal, a control switch for controlling the adapter to output the electric energy, and an adapter controller for receiving a signal sent by the battery controller and stopping the adapter outputting the electric energy through the control switch when a length of time that the voltage of the battery pack is less than a voltage threshold reaches a predetermined length of time. The second communication terminal is electrically connected with the adapter controller.

In another aspect of the disclosure, an adapter for a battery pack is provided. The adapter includes an input positive terminal for connecting with a battery pack positive terminal of the battery pack, an input negative terminal for connecting with a battery pack negative terminal of the battery pack, a control switch for controlling the adapter to output electric energy, and an adapter controller for receiving a signal sent by the battery pack and stopping the adapter outputting the electric energy when a length of time that the voltage of the battery pack is less than a voltage threshold reaches a predetermined length of time.

In yet another aspect of the disclosure, an over-discharge protection method of a battery pack which outputs electric energy through an adapter is provided. The method includes detecting a voltage of the battery pack, determining whether the voltage of the battery pack is less than a voltage threshold, when the voltage of the battery pack is less than the voltage threshold, recording a length of time that the battery pack sends a signal about the voltage of the battery pack to the adapter, determining whether the length of time is greater than a predetermined length of time, and when the length of time is greater than the predetermined length of time, stopping the adapter outputting the electric energy.

In yet another aspect of the disclosure, an over-discharge protection method of a battery pack is provided. The method includes detecting voltage of the battery pack, determining whether the voltage of the battery pack is less than a voltage threshold, and when a length of time that the voltage of the battery pack is less than the voltage threshold is greater than a predetermined length of time, stopping the battery pack discharging.

In yet another aspect of the disclosure, a power supply device is provided. The power supply device includes a battery pack for storing electric energy and an adapter for outputting the electric energy stored in the battery pack. The battery pack includes a battery controller for detecting the voltage of the battery pack. The adapter includes an adapter controller for receiving a signal sent by the battery controller and stopping the adapter outputting the electric energy when a length of time that the voltage of the battery pack is less than a voltage threshold reaches a predetermined length of time.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of an exemplary power supply device.

FIG. 2 is a schematic view of a battery pack of the power supply device in FIG. 1.

FIG. 3 is a schematic view of an adapter of the power supply device in FIG. 1.

FIG. 4 is a circuit block diagram of the power supply device.

FIG. 5 is a flowchart illustrating an exemplary method for preventing the battery pack of the power supply device from over-discharging.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

The following description of the preferred embodiments is merely exemplary in nature and is in no way intended to limit the scope of the invention hereinafter claimed, its application, or uses.

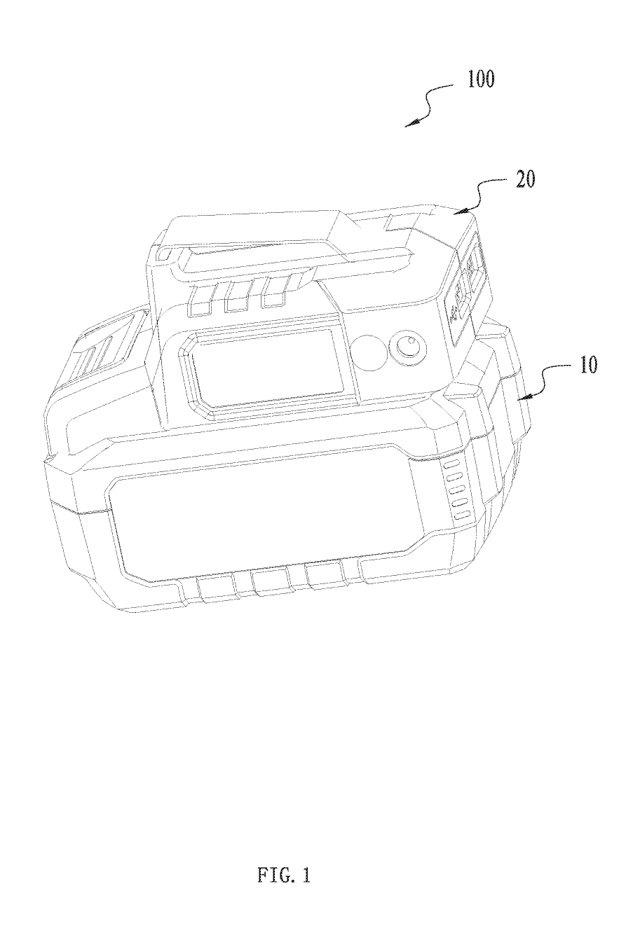

Referring to FIGS. 1-4, a power supply device for a power tool includes a battery pack 10 and an adapter 20.

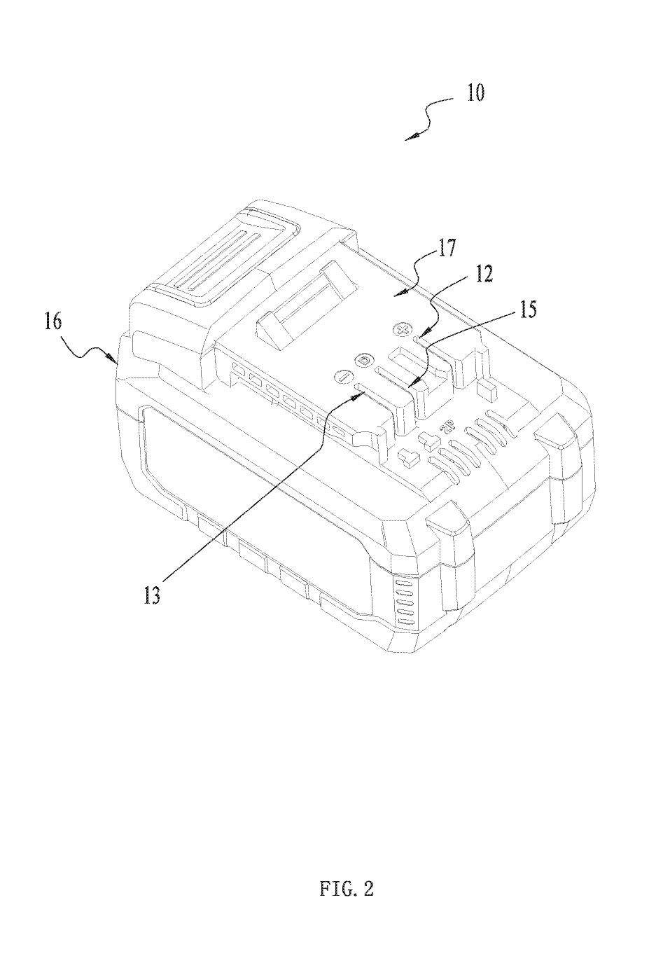

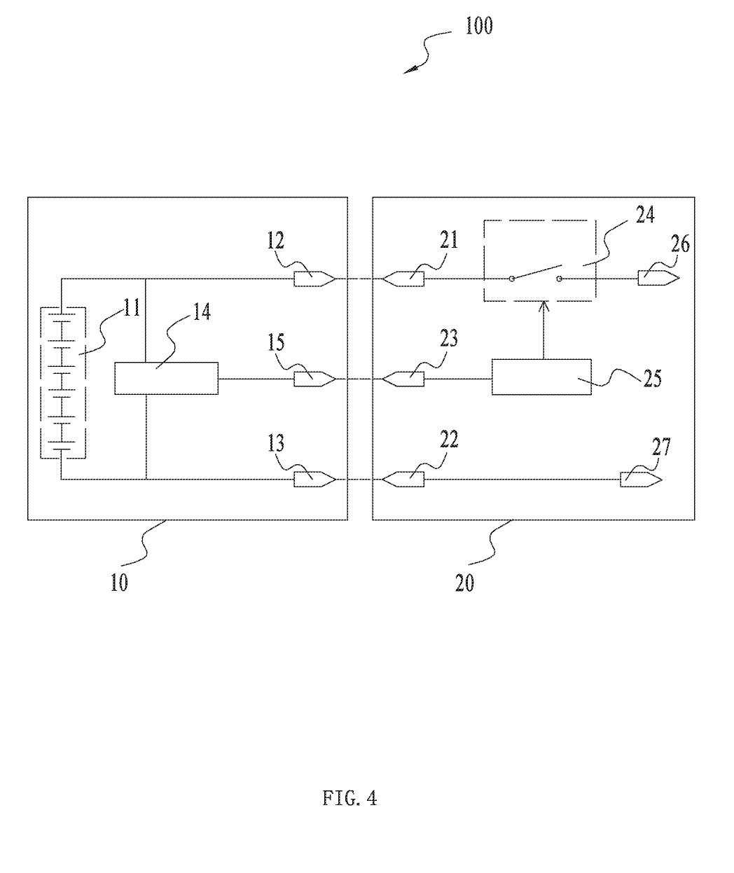

As shown in FIGS. 2 and 4, the battery pack 10 at least includes a plurality of cells 11 for storing electric energy and a first housing 16 for containing the cells 11. The first housing 16 is formed with a first coupling portion 17 which allows the battery pack 10 to couple with the adapter 20. When the battery pack 10 is coupled with the adapter 20, the battery pack 10 is electrically connected with the adapter 20. When the battery pack 10 is separated from the adapter 20, the battery pack 10 is able to directly or independently supply the electric energy to a power tool.

The number and connection method of the cells 11 can be chosen according to the actual demand of the electric energy. As shown in FIG. 4, the plurality of cells 11 has a positive electrode and a negative electrode. The positive electrode is connected with a battery pack positive terminal 12 of the battery pack 10, and the negative electrode is connected with a battery pack negative terminal 13 of the battery pack 10. The battery pack 10 outputs the electric energy through the battery pack positive terminal 12 and the battery pack negative terminal 13. A battery controller 14 is able to detect a voltage of the battery pack 10, namely, the voltage between the battery pack positive terminal 12 and the battery pack negative terminal 13. The battery controller 14 is connected with a first communication terminal 1515.

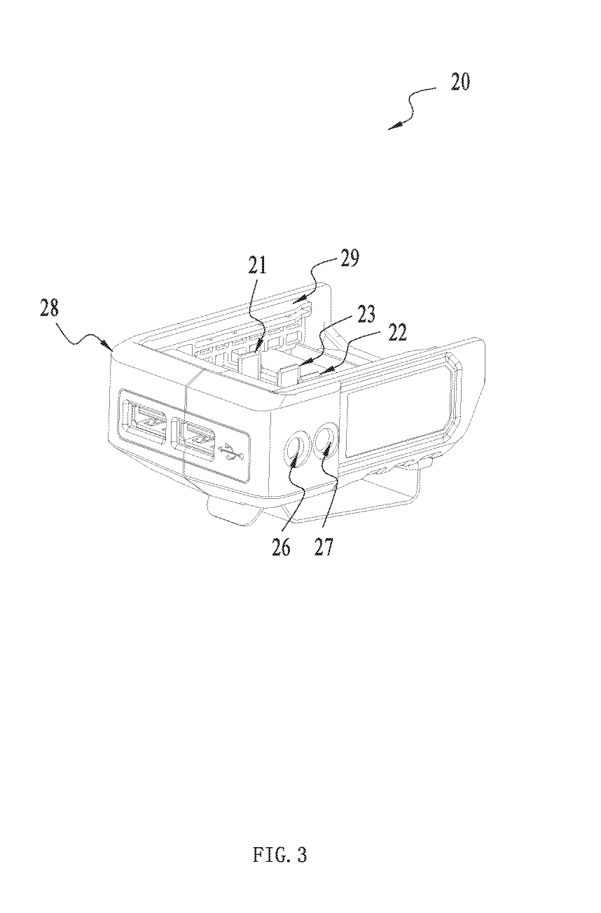

As shown in FIG. 3, the adapter 20 at least includes a second housing 28, an input positive terminal 21, an input negative terminal 22 and a second communication terminal 23. The second housing 28 is formed with a second coupling portion 29 for coupling with the first coupling portion 17. When the first coupling portion 17 of the battery pack 10 is coupled with the second coupling portion 29, the input positive terminal 21 is connected with the battery pack positive terminal 12, the input negative terminal 22 is connected with the battery pack negative terminal 13, and the second communication terminal 23 is connected with the first communication terminal 1515. Specifically, the second coupling portion 29 is formed with a socket. The input positive terminal 21, the input negative terminal 22 and the second communication terminal 23 are all disposed in the socket.

As shown in FIG. 4, the adapter 20 further includes a control switch 24, an adapter controller 25, an output positive terminal 26 and an output negative terminal 27. The adapter controller 25 can receive a signal output by the battery controller 14. The second communication terminal 23 is connected with the adapter controller 25. When the second communication terminal 23 is connected with the first communication terminal 1515, the battery pack 10 and the adapter 20 can carry out data communication and signal interaction therebetween. The output positive terminal 26 for outputting the electric energy is electrically connected with the input positive terminal 21, and the output negative terminal 27 is electrically connected with the input negative terminal 22. The control switch 24 is disposed in series on a current path from the input positive terminal 21 and the input negative terminal 22 to the output positive terminal 26 and the output negative terminal 27. The adapter controller 25 controls the control switch 24 to turn on and off so as to control the adapter 20 to output the electric energy. The adapter 20 further includes a voltage converting module, so the voltage of the battery pack 10 can be converted to match an electrical appliance through the adapter 20 before being supplied to the electrical appliance.

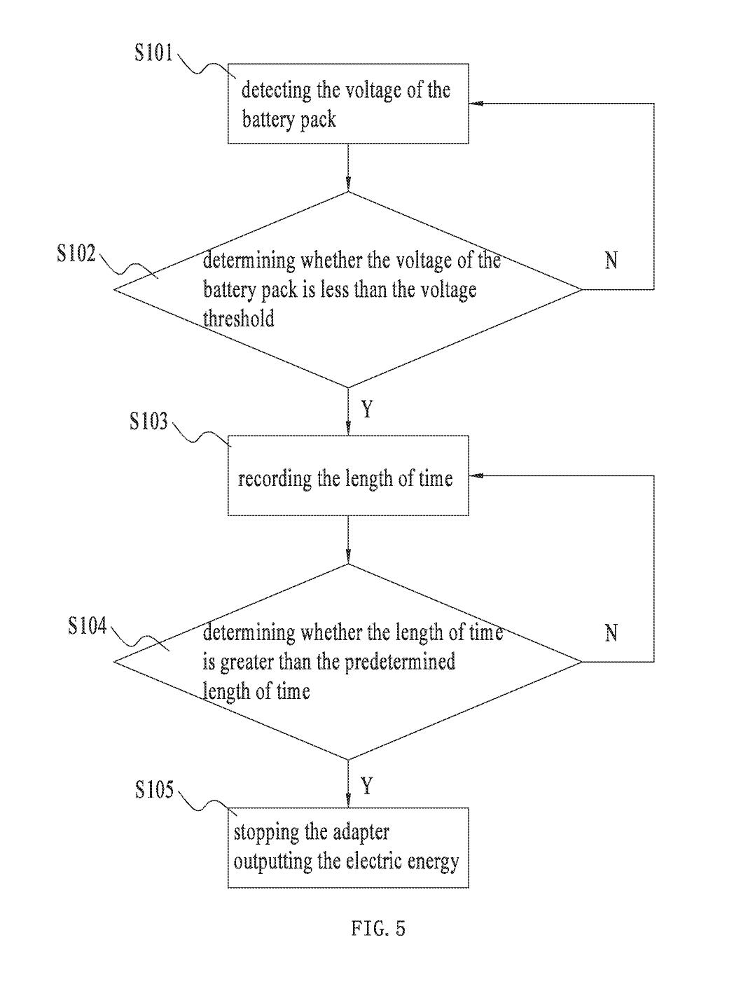

As shown in FIG. 4, the controller 14 and the adapter controller 25 are constituted by a microprocessor based on CPU, MCU, or the like, which carry out voltage detection and control function through built-in control programs. The adapter controller 25 can execute a control process to prevent the battery pack 10 from over-discharging when the adapter 20 outputs the electric energy according to the process as shown in FIG. 5. The control process is the main process which will be described in detail hereinafter.

The battery pack 10 communicates with the adapter 20, which is for stopping the adapter controller 25 of the adapter 20 from outputting the electric energy when the battery pack 10 is over-discharged so as to avoid the cells 11 of the battery pack 10 being in an over-discharge status. When the battery pack 10 supplies the electric energy to the electrical appliance through the adapter 20, the voltage of the cells 11 drops gradually along with the decline of the stored electric energy, namely, the battery pack 10 is close to an undervoltage threshold along with the increase of service time. Thereby, for protecting the battery pack 10, it is preferred to ensure that the adapter 20 can give feedback and protection timely when the battery pack 10 is close to the undervoltage threshold.

A discharge protection process executed by the adapter controller 25 of the adapter 20 is illustrated as follow.

The discharge protection process is executed by the adapter controller 25 in real time taking the time as the unit.

On the one hand, the adapter controller 25 turns on the adapter control switch 24 so that the battery pack 10 supplies the electric energy to the electrical appliance through the adapter 20. Because the electrical appliance works and consumes the electric energy of the battery pack 10, the battery pack 10 is in the discharge status.

On the other hand, the adapter controller 25 receives a status signal of the battery pack 10 which is output by the battery controller 14. Here, the status signal of the battery pack 10 includes a current signal and a voltage signal detected at a certain sampling frequency in the battery pack 10. Specifically, the status signal is the voltage signal of the battery pack 10 detected by the battery controller 14.

Whether the voltage of the battery pack 10 is less than a voltage threshold is determined. The setting of the voltage threshold is related to a nominal voltage of the battery pack 10, the undervoltage threshold of the battery pack 10 and the maximum output voltage that the adapter 20 can carry. Alternatively, a range of the voltage threshold can be between the nominal voltage and the undervoltage threshold of the battery pack 10. However, the adapter 20 may be connected with different electrical appliances, so the corresponding voltage thresholds are different. The appropriate voltage thresholds can be chosen and written in the adapter controller 25 according to the actual design requirements.

When the voltage of the battery pack 10 is determined to be less than the voltage threshold, a length of time of discharge between the battery pack 10 and the adapter 20 is recorded, otherwise, the voltage of the battery pack 10 is continually collected until it is less than the voltage threshold. When the voltage of the battery pack 10 is less than the voltage threshold, it shows that the battery pack 10 is close to the over-discharge status.

Whether the length of time of discharge is greater than a predetermined length of time is determined. The setting of the predetermined length of time is related to the capacity of the battery pack 10 (including the total capacity of the battery pack 10 and the remaining capacity of the battery pack 10), the maximum power that the adapter 20 can carry, and a working current of the adapter 20. Alternatively, the predetermined length of time can be a ratio between the maximum power that the adapter 20 can carry and the working current of the adapter 20. It will be appreciated that detecting the voltage of the battery pack 10 to obtain the voltage of a single cell and setting a predetermined voltage threshold for the signal cell should be considered as an equivalent method. However, when the adapter 20 is connected with different battery packs and different electrical appliances, it will affect the setting of the predetermined length of time. For an actual product, it is preferred to simply choose the appropriate predetermined length of time according to the requirements of the product.

When the length of time of discharge is greater than or equal to the predetermined length of time, the adapter controller 25 outputs a signal to turn off the control switch 24 so as to stop the adapter 20 outputting the electric energy. If the length of time of discharge is less than the predetermined length of time, timing is continued until the predetermined length of time is reached. And the discharge control of the adapter controller 25 is ended.

The frequency of sending the voltage signal of the battery pack 10 from the battery pack 10 to the adapter 20 is defined as a single frequency. When the voltage of the battery pack 10 is less than the voltage threshold, the battery pack 10 is about to get into the over-discharge status. When the length of time of discharge that the voltage of the battery pack 10 is less than the voltage threshold reaches the predetermined length of time, the adapter controller 25 outputs the signal to turn off the control switch 24 so as to stop the adapter 20 outputting the electric energy, so the battery pack 10 is avoided from over-discharging. It is needed to set a calculation formula in which the voltage is regarded as a variable parameter in the adapter controller 25 having the computing capability. Then the control signal of turning off the control switch 24 can be output through comparing the actual voltage and the voltage threshold. Taking the battery pack 10 with 18V nominal voltage as an example, the predetermined voltage threshold may be 17V, and the predetermined length of time which is the length of time when the adapter 20 discharges with its maximum discharging capacity may be, for example, 60 s. When the detected voltage of the battery pack 10 is less than 17V, after keeping the battery pack 10 communicating with the adapter 20 for 60 s, the adapter controller 25 turns off the control switch 24 so as to stop the adapter 20 outputting the electric energy.

Further, the communication between the battery pack 10 and the adapter 20 consumes the electric energy of the battery pack 10. In order to save the electric energy consumed due to the communication between the battery pack 10 and the adapter 20, the adapter controller 25 reduces the signal frequency when the voltage of the battery pack 10 is less than the predetermined voltage threshold. That is, the signal frequency when the voltage of the battery pack 10 is greater than the predetermined voltage threshold is greater than the one when the voltage of the battery pack 10 is less than the predetermined voltage threshold.

Generally, in order to determine whether the battery pack 10 is over-discharged, it is preferred to set a high sampling frequency and signal frequency to ensure that the voltage detection of the battery pack 10 is accurate. However, the high sampling frequency and signal frequency consume a lot of electric energy of the battery pack 10 and simply reducing the sampling frequency and signal frequency can affect the over-discharge determination of the battery pack 10. So, in order to ensure the accuracy of the over-discharge determination of the battery pack 10 while reducing the consumption of electric energy due to the communication between the battery pack 10 and the adapter 20, an over-discharge protection method of the battery pack which outputs the electric energy through the adapter is provided. The method includes steps as follows:

S101 detecting the voltage of the battery pack;

S102 determining whether the voltage of the battery pack is less than the voltage threshold;

S103 when the voltage of the battery pack is less than the voltage threshold, recording the length of time that the battery pack sends the signal about the voltage to the adapter;

S104 determining whether the length of time is greater than the predetermined length of time;

S105 when the length of time is greater than the predetermined length of time, stopping the adapter outputting the electric energy.

As another embodiment, the voltage threshold is stored in the corresponding controller, which is set according to the nominal voltage of the battery pack and the undervoltage threshold of the battery pack. The range of the voltage threshold is between the nominal voltage of the battery pack and the undervoltage threshold of the battery pack.

It is noted that, detecting the voltage of the battery pack to obtain the voltage of a single cell and setting the voltage threshold for the single cell should be considered as an equivalent method as the method described above.

The predetermined length of time is stored in the corresponding controller, which is less than or equal to a ratio between the maximum power that the adapter can carry and the work current of the adapter. It is noted that, when the adapter includes two output ports for outputting different voltages to adapt different electrical appliances, for example, a USB port and a 12V DC port, different predetermined lengths of time are set to correspond to different output capabilities of different output ports. The two different predetermined lengths of time are all stored in the adapter controller of the adapter. The corresponding predetermined length of time is output according to the output port through the adapter controller.

Furthermore, in order to further save the electric energy, the signal frequency of the battery pack is reduced when the voltage is less than the voltage threshold. Specifically, when the voltage of the battery pack is greater than or equal to the voltage threshold, the signal frequency about the voltage of the battery pack sent by the battery pack is defined as a first signal frequency. When the voltage of the battery pack is less than the voltage threshold, the signal frequency about the voltage of the battery pack sent by the battery pack is adjusted to a second signal frequency. The second signal frequency is less than the first signal frequency.

Alternatively, the sampling frequency of the voltage of the battery pack is set to be equal to the signal frequency of communication between the adapter and the battery pack.

Furthermore, the communication between the adapter and the battery pack can be initiated by the battery pack and can also be initiated by the battery pack after the battery pack being activating by the adapter. The time interval between two communications (which is inversely proportional to the signal frequency can be controlled by the battery pack or the adapter.

Similarly, based on the same design concept, the method which keeps the battery pack working and makes it satisfy the predetermined length of time according to the determination of the voltage threshold also can be used to stop the battery pack from discharging. A method for preventing the battery pack from over-discharging includes the following steps:

detecting the voltage of the battery pack,

determining whether the voltage of the battery pack is less than the predetermined voltage threshold,

when the voltage of the battery pack is less than the voltage threshold and the length of time is greater than the predetermined length of time, stopping the battery pack discharging.

Using the method to stop the battery pack discharging has an advantage that is the discharge of the battery pack can be turned off totally, which avoids the consumption of the electric energy being continued within the battery pack.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the invention hereinafter claimed.

What is claimed is:

1. A power supply device for a power tool, comprising:
a battery pack for supplying electric energy to at least a power tool; and
an adapter for outputting the electric energy stored in the battery pack;
wherein the battery pack comprises:
a plurality of cells for storing the electric energy;
a battery pack positive terminal connected with a positive electrode of each of the plurality of cells;
a battery pack negative terminal connected with a negative electrode of each of the plurality of cells;
a battery controller for detecting a voltage of the battery pack; and
a first communication terminal electrically connected with the battery controller;
wherein the adapter comprises:
an input positive terminal for connecting with the battery pack positive terminal;
an input negative terminal for connecting with the battery pack negative terminal;
a second communication terminal for electrically connecting with the first communication terminal;
an adapter control switch for controlling the adapter to output the electric energy; and
an adapter controller for receiving a signal sent by the battery controller and stopping the adapter outputting the electric energy through the control switch when a length of time that the battery pack has the voltage less than a predetermined voltage threshold reaches a predetermined length of time;
wherein the second communication terminal is electrically connected with the adapter controller.

2. The power supply device of claim 1, wherein a frequency of the signal about the voltage of the battery pack sent by the battery controller to the adapter controller is defined as a signal frequency and the signal frequency at which the voltage of the battery pack is less than the voltage threshold is less than that signal frequency at which the voltage of the battery pack is greater than the voltage threshold.

3. An adapter for a battery pack of a power tool, comprising:
an input positive terminal for connecting with a battery pack positive terminal of the battery pack;
an input negative terminal for connecting with a battery pack negative terminal of the battery pack;
an adapter control switch for controlling the adapter to output electric energy; and
an adapter controller for receiving a signal sent by the battery pack and stopping the adapter outputting the electric energy when a length of time that the battery pack has the voltage less than a predetermined voltage threshold reaches a predetermined length of time.

4. The adapter of claim 3, wherein a frequency of the signal about the voltage of the battery pack sent by the battery pack to the adapter is defined as a signal frequency and the signal frequency at which the voltage of the battery pack is less than the voltage threshold is less than that one at which the voltage of the battery pack is greater than the voltage threshold.

5. The adapter of claim 3, wherein the adapter is used for adapting the battery pack that supplies the electric energy to the power tool to supply the electrical energy to another device.

6. An over-discharge protection method of a battery pack which outputs electric energy through an adapter for a power tool, comprising:
detecting voltage of the battery pack;
determining whether the voltage of the battery pack is less than a predetermined voltage threshold;
recording a length of time that the battery pack sends a signal about the voltage of the battery pack to the adapter when the voltage of the battery pack is less than the voltage threshold;
determining whether the length of time is greater than a predetermined length of time; and
stopping the adapter outputting the electric energy when the length of time is greater than the predetermined length of time.

7. The method of claim 6, wherein a frequency of the signal about the voltage of the battery pack sent by the battery pack to the adapter is defined as a signal frequency and the signal frequency at which the voltage of the battery pack is less than the voltage threshold is less than that signal frequency at which the voltage of the battery pack is greater than the voltage threshold.

8. An over-discharge protection method of a battery pack for a power tool, comprising:
detecting a voltage of the battery pack;
determining whether the voltage of the battery pack is less than a voltage threshold; and
stopping the battery pack discharging when a length of time that the battery pack has the voltage less than the voltage threshold is greater than a predetermined length of time.

9. The method of claim 8, wherein a frequency of a signal about the voltage of the battery pack sent by the battery pack is defined as a signal frequency, and the signal frequency at which the voltage of the battery pack is less than the voltage threshold is less than that one at which the voltage of the battery pack is greater than the voltage threshold.

10. A power supply device for a power tool, comprising:
a battery pack for storing electric energy; and
an adapter for outputting the electric energy stored in the battery pack;
wherein the battery pack comprises:
a battery controller for detecting the voltage of the battery pack;
wherein the adapter comprises:
an adapter controller for receiving a signal sent by the battery controller and stopping the adapter outputting the electric energy when a length of time that the battery pack has the voltage of is less than a predetermined voltage threshold reaches a predetermined length of time.
